(19) United States
(12) Patent Application Publication
(10) Pub. No.: US 2007/0135110 A1
(43) Pub. Date: Jun. 14, 2007

(54) Smart call list

(75) Inventors: Anant Athale, Schaumburg, IL (US); Thomas M. Tirpak, Glenview, IL (US); Dale R. Crosby, Coral Springs, FL (US); Jose E. Korneluk, Lake Worth, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/296,953

(22) Filed: Dec. 8, 2005

(51) Int. Cl. H04M 3/00

(52) U.S. Cl. 455/418

(57) ABSTRACT

A smart call list for a wireless mobile device (12) can include a storage medium (14 or 304) containing a call list having a plurality of contact entries (19) and a processor (302) coupled to the storage medium. The processor can monitor (902) the use of the call list according to a plurality of criteria to intelligently improve the chances of successfully contacting the entries on the call list. The processor can rank (903) the plurality of criteria and assign (906) relative weights to the plurality of criteria to facilitate a selection and order of the contact entries to call (904). The processor can further automatically select (908) a next best number to call if an attempt to connect with a current number is unsuccessful. In one arrangement, the smart call list can use a phone tree (30) in an attempt to contact members of the call list.

### FIELD

This invention relates generally to communication devices, and more particularly to a method and system of successfully reaching people on a call list.

### BACKGROUND

The phonebook management and autodialer (call list) applications currently available are essentially static in nature with insufficient capabilities for learning and adapting to user interaction and actual calling patterns. Such systems and applications fail to make the best, efficient efforts in potentially reaching people on a call list. Some autodialers, for example, include a call list management application and interface to the telephone network further including a Service Control Point (SCP) mechanism for call lists. The SCP mechanism is a simple failover method in which the next number is picked if the number being dialed fails. It is also known that lists of phone numbers can be saved in the mobile device's memory or on a removable memory device. The contents can be shared with other applications, e.g., uploading to an MS Outlook contacts list. Some mobile devices can include a method for automatically updating phone books for multiple devices (subscribers) to reflect the change in a user's telephone number.

When it comes to trying to reach everyone on user's call list, the existing solutions are generally inadequate because such solutions are for network-centric solutions, i.e., services for managing and sharing phonebooks. For mobile devices, minimal functionality is typically implemented on a Subscriber Identity Module (SIM) card. Phonebooks in mobile devices or SIM cards may include contact information and some very limited statistical information about the phone number to be called, e.g., success ratio. Furthermore, device-centric solutions fail to automatically update phone books based on calling history or patterns

### SUMMARY

Embodiments herein can complement currently available static lists and offer advanced features to improve the user experience, scalability, and cost effectiveness of a communication system. A Smart Call List (SCL) introduces a new paradigm for wireless connectivity that can be dynamic, intelligent and seamless. A system using smart call lists can provide enhanced call lists that are dynamic, adaptive, collaborative and auto-configuring. It can likewise manage the exchange of call list management information, e.g., subsets of a ‘phone tree’ for call delegation. SCLs can offer the means to define call lists that are structured, have built-in intelligence and can also be trained according to user-specific requirements.

In a first embodiment of the present invention, a smart call list for a wireless mobile device can include a storage medium in the wireless mobile device containing a call list having a plurality of contact entries and a processor coupled to the storage medium. The processor can be programmed to monitor the use of the call list according to a plurality of criteria gathered or computed to intelligently improve the chances of successfully contacting the plurality of contact entries on the call list. The processor can rank the plurality of criteria and monitor the plurality of criteria selected among the criteria of best times to call a particular contact entry for a given person, statistics about the call frequency, success rate of reaching the given person at a given contact entry, success rate of leaving a call back number, average duration of calls, or cost of calling the particular contact entry based on network considerations. The processor can be further programmed to assign relative weights to the plurality of criteria to facilitate a selection, thereby determining the order of the contact entries with which to establish contact. The relative weights can be adjusted by a user. The processor can further be programmed to automatically select a next best number to call if an attempt to connect with a current number is unsuccessful. The selection of the next best number to call can be based on metadata associated with all alternative numbers for a given contact. Furthermore, calls can be made recursively until a successful call is made or until the list is exhausted. In one arrangement, the smart call list can use a phone tree in an attempt to contact members of the call list. The smart call list can enable the creation of dynamic groups among members of the call list to form the phone tree.

In a second embodiment of the present invention, a method of traversing a call list having a plurality of contact entries in a wireless mobile device can include the steps of monitoring the use of the call list according to a plurality of criteria gathered or computed to intelligently improve the chances of successfully contacting the plurality of contact entries on the call list, ranking the plurality of criteria, and calling at least a portion of the plurality of contact entries in an order in accordance with the rank. The plurality of criteria can be selected among criteria of best times to call a particular contact entry for a given person, statistics about the call frequency, success rate of reaching the given person at a given contact entry, success rate of leaving a call back number, average duration of calls, or cost of calling the particular contact entry based on network considerations. The selection and order of the contact entries to contact can be facilitated by assigning relative weights to the plurality of criteria which can be selectively adjustable by a user. The method can automatically select a next best number to call if an attempt to connect with a current number is unsuccessful. The selection of the next best number to call can be based on metadata associated with all alternative numbers for a given contact. Calls can be made recursively until a successful call is made or until the list is exhausted. In one arrangement, the call list uses a phone tree in an attempt to contact members of the call list. The call list can enable the creation of dynamic groups among members of the call list to form the phone tree.

In a third embodiment of the present invention, a wireless mobile device having a smart call list can include a transceiver, a storage medium in the wireless mobile device containing a call list having a plurality of contact entries, and a processor coupled to the storage medium and the transceiver. The processor can be programmed to monitor the use the plurality of contact entries of the call list according to a plurality of criteria gathered or computed to intelligently improve the chances of successfully contacting the plurality of contact entries on the call list, and call at least a portion of the plurality of contact entries in an order determined by the plurality of criteria. The processor can further be programmed to monitor and rank the plurality of criteria by assigning relative weights to the plurality of criteria, where the plurality of criteria are selected among best times to call a particular contact entry for a given person, statistics about the call frequency, success rate of reaching the given person at a given contact entry, success rate of leaving a call back number, average duration of calls, or cost of calling the particular contact entry based on network considerations.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine-readable storage for causing a machine to perform the various processes and methods disclosed herein.

### BRIEF DESCRIPTION OF THE DRAWINGS

FIG. 1 is an illustration of a wireless mobile device having a smart call list in accordance with an embodiment of the present invention.

FIG. 2 is a user interface illustrating a smart call list in accordance with an embodiment of the present invention.

FIG. 3 is a phone tree in accordance with an embodiment of the present invention, where the links between nodes A through J represent a pattern of connections between multiple wireless mobile devices.

FIG. 4 is a block diagram of a smart call list architecture in accordance with an embodiment of the present invention.

FIG. 5 is a flow chart illustrating a method of traversing through a smart call list in accordance with an embodiment of the present invention.

FIG. 6 is a flow chart illustrating another aspect of a method of traversing through a smart call list in accordance of an embodiment of the present invention.

FIG. 7 is a flow chart continuing the method illustrated in FIG. 6 in accordance with an embodiment of the present invention.

FIG. 8 is a system including a wireless mobile device having a smart call list in accordance with an embodiment of the present invention.

FIG. 9 is a flow chart illustrating a method of traversing a smart call list in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

The embodiments herein can address a fundamental need to successfully reach all the people in a call list, particularly when there are multiple ways to reach them. A call list can have multiple phone numbers or contact addresses for each person in the call list. Additionally, there can be the possibility of delegating a subset of the calls to be made to other people (if they can be reached).

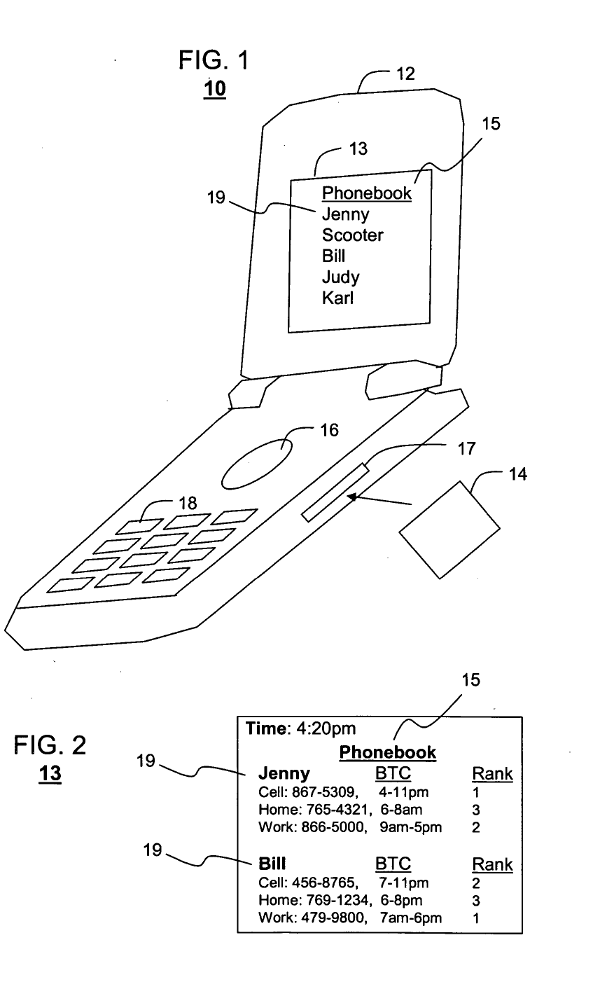

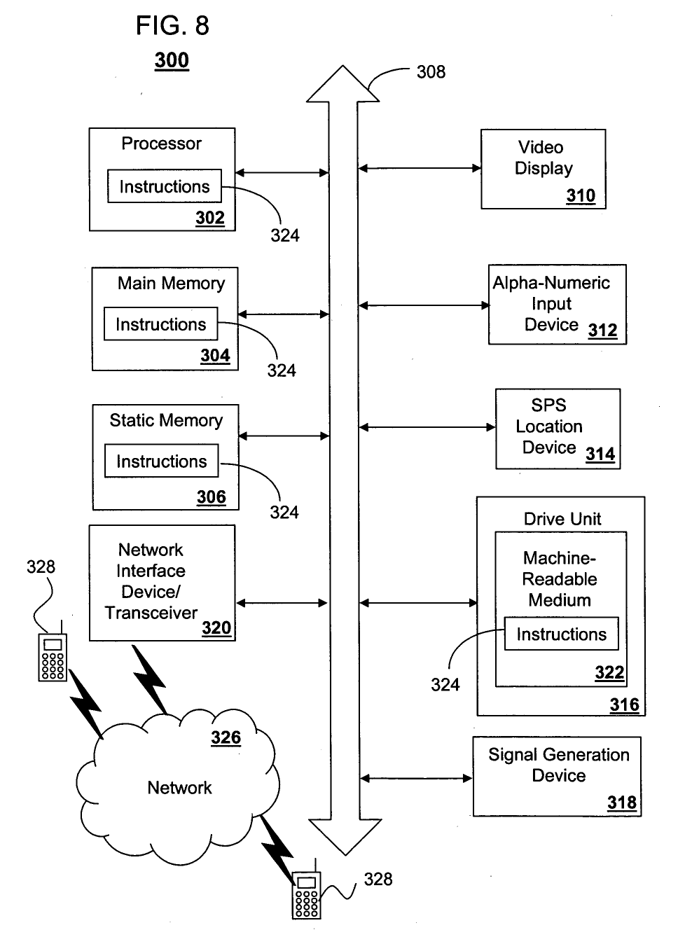

Referring to FIG. 1, an electronic device 10 such as a cellular phone, a smart phone, a cordless home phone, a personal digital assistant, a wireless messaging device, a laptop computer, or other mobile communication device can include a storage medium 14 (such as memory in the form of a memory stick, a subscriber identity module (SIM) card, flash memory, embedded memory, etc.) having stored therein a call list or smart call list as contemplated herein. The call list can be part of a phonebook 15 illustrated on a display or user interface 13 and can include a plurality of entries 19. Each of the entries 19 can have one or more contact number or addresses as illustrated in FIG. 2. The electronic device 10 can be a wireless communication device 12 further including a key or keypad 18 and/or a navigation key 16. Note, if the wireless device 12 includes a SIM card, it can include a slot 17 for interfacing with the SIM card. The processor (see FIG. 8) in the electronic device 10 can be programmed to operate the electronic device 10 in accordance with the methods further described below.

A Smart Call List (SCL) can introduce a new paradigm for wireless connectivity that is dynamic, intelligent and seamless. The new paradigm complements the currently available static lists and offers advanced features to improve a user experience, scalability, and cost effectiveness of the communication system. SCLs can offer the means to define call lists that are structured, have built-in intelligence and can also be trained according to user-specific requirements. More particularly, SCL's can intelligently select and also suggest the best numbers to call based on the information that is associated with the person (subscriber) to be contacted. For example with reference to FIG. 2, based on the user's calling plan the best times to call a cellular phone number may be between 7 pm-11 pm, and for other times a different number can be specified such as a work number. This information can be contained in the metadata and is always available. Thus, when a call is placed to a particular person, the system will automatically choose the appropriate number to call based on the current time-of-the-day (currently 4:20 pm as illustrated), optimizing the call's cost efficiency and also the probability of successfully reaching the person. The intelligent list based functions and SCL structure are described in the sections below.

The Smart Call List (SCL) can intelligently contact members of a call list in a dynamic, collaborative, scalable, and flexible fashion. The SCLs can be dynamic since they can continuously monitor the user's interaction with a telecommunication system. The SCL can reconfigure itself to adapt to the user's calling patterns if desired. SCLs can be also be easily shared, and new groups can be dynamically created, thereby overcoming the inherent limitations of static lists that have features limited to ‘Call one person’, ‘broadcast to many’, or ‘conference calling’. As will be discussed below, SCL enable “smart” variations of existing features that in many embodiments does not necessarily require additional resources from a telecommunication infrastructure. The SCLs can be based on dynamic groups that can be called recursively, in a way that selects the best phone number (or numbers) to reach a given person.

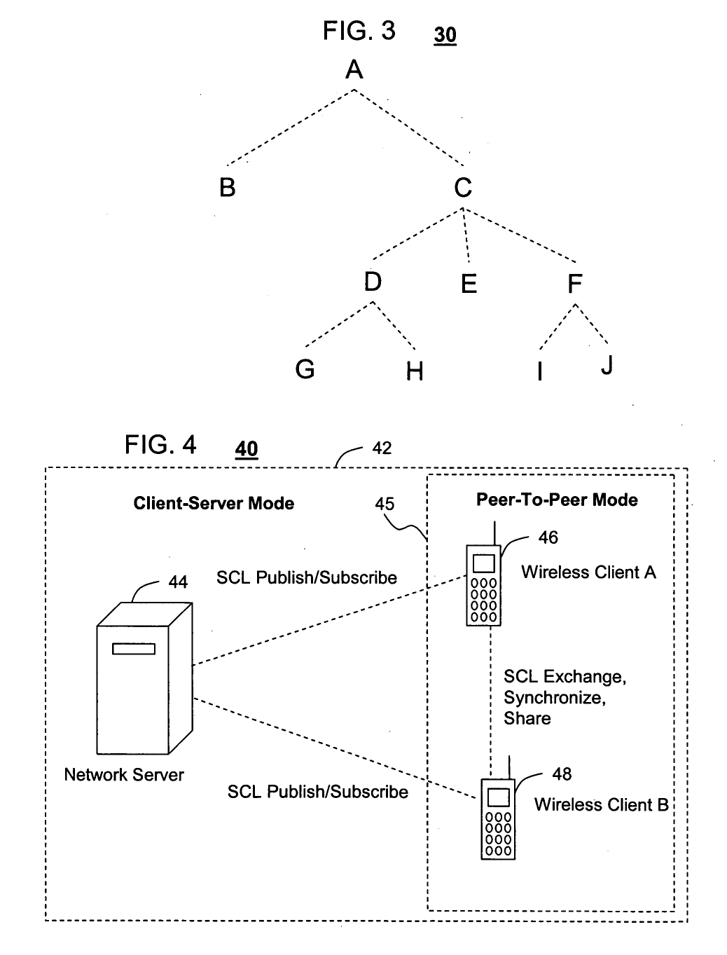

As illustrated in FIGS. 3 and 4, the SCL information can be used in a collaborative fashion since SCLs can be shared in a collaborative fashion (peer to peer, client-server) which further increases the knowledge base of the SCLs and improves their accuracy and effectiveness. This includes phone numbers, metadata about the numbers and their related calling history, as well as ‘phone tree’ control information for one or more collaborative groups. In particular, FIG. 3 illustrates a phone tree 30 that can be used to proliferate information to members of a call list as will be further explained. Referring to FIG. 4, a smart call list architecture 40 that can operate in a client-server mode 42 or a peer-to-peer mode 45 or both. In the client-server mode (42), a network server 44 can publish or provide a subscription to a plurality of wireless clients 46 and 48. In a peer-to-peer mode (45), the wireless clients 46 and 48 can exchange, synchronize and/or share their SCLs.

With respect to SCLs being scalable and flexible, the SCL metadata and the associated intelligence can be persistent on the client-side, i.e., on the device that is making the phone call, rather than in a database associated with the network infrastructure. For example, phone book management software can be modified or enhanced to support additional metadata such as alternate calling numbers, preferred calling times, and calling pattern statistics. Supporting applications running under a phone's operating system (J2ME, Windows CE, Linux, P2K, etc.) can also handle the additional computation for collecting and interpreting the calling statistics (metadata) as well as managing the call and data hand-off for using a hierarchical ‘calling tree’ as illustrated in FIG. 3. This feature enables the SCL to be very scalable. New (wireless orwired) clients can be added to the system without significantly increasing the network overhead. Because the SCLs are decoupled from the network's server-side infrastructure, they are very flexible and maintainable. The client-side management of intelligence reduces the server dependency. Such a system can support both synchronous and asynchronous group communication using Push-To-Talk technology and can also enable a new mode of Seamless Mobility communication and collaboration among groups of callers.

The call list support both hierarchical and flat structures. Flat SCLs can contain a simple (flat) list of phone numbers for a phone book contact. Each number can have associated metadata to provide additional information that helps the system make intelligent decisions regarding how to place the call (or calls). The metadata can include the following attributes: best times to call, statistics about the call frequency, success rate of reaching the person at the given number, success rate of leaving a call back number, average duration of the calls, etc. These attributes can also be ranked to facilitate the selection of the phone number (or numbers) to call. This ranking indicates the relative weights of the various attributes. The weights can be adjusted based on the user needs.

A hierarchical SCL can be used to define call groups. The ‘call group’ can be a collection of phone book contacts. Each ‘call group’ has a defined set of use cases associated with it. Such use cases can include the ability to be shared with other users, sorting, adding, and deleting the entries in the ‘call group’ and nesting ‘sub groups’. The entries in the ‘call group’ have the same types of metadata associated with them as the ‘flat list’ entries.

Smart Call List functions can be categorized according to behavioral and structural functions. Behavioral functions can include “one call”, “call all”, “phone tree” and “share” functions. Structural functions can include functions such as create, update, delete, synchronize, and sort. Structural functions can also include attribute extensions. Both behavioral and structure functions are further detailed below.

With respect to behavioral functions, the One-Call function is an intelligent call forwarding function that automatically selects the next best number to call, if the attempt to connect with the current number is unsuccessful. The selection of the next number can be based on the metadata associated with all the alternate numbers for the contact. The selection can take into account the various factors and their relative weights as defined in the metadata. The calls can be made recursively until a successful call is made or until the list is exhausted. The list also suggests the best number to call when the call is first initiated, i.e., the preferred starting point in the SCL. In a proposed implementation, the user can be given the option to override the suggestion and pick a different number in the list with which to initiate the call. In this case, the system adjusts the SCL to learn the user override behavior and gather statistics for each interaction. The list also gathers statistics for each call and tracks the success rate, frequency and duration of the calls. This continuous learning of the user's interaction with the list makes the list smarter with each call that is made. The combined statistics for the user interaction and calls drive the list reorganization and continuously improve the number selection process. All the statistics are tracked on the client (mobile or stationary calling device) and also reside on the client unless the user chooses to upload or share them with server-based network services.

The “Call All” function is an extension to the ‘One Call’ function and is applicable in group calls. The ‘Call All’ function utilizes the hierarchical SCLs as described above and calls the contacts in the group sequentially and/or recursively until the list is exhausted. The calls automatically cascade into subgroups (if they exist) calling the sub-group entries recursively and continue on to the parent list. The SCL management system automatically chooses the best number to call for each contact in the group based on the selection process described under the ‘One Call’ function.

With reference to the phone tree 30 of FIG. 3 again, the phone tree function allows the creation of dynamic groups which is explained in the following scenario. User ‘A’ creates the calling tree and then calls users ‘B’ and ‘C’. When ‘C’ is contacted, the calling tree (or relevant sub-tree) is automatically published to ‘C’. ‘C’ then calls ‘D’, ‘E’, and ‘F’. When ‘D’ is contacted, the calling tree (or relevant sub-tree) is automatically published to ‘D’. When ‘F’ is contacted, the calling tree (or relevant sub-tree) is automatically published to ‘F’. ‘D’ then calls ‘G’ and ‘H’. ‘F’ then calls ‘I’ and ‘J’. In another mode of operation, e.g., “Find the answer in the organization”, the (lowest level) node at which the answer/solution/resolution is found, calls ‘A’ to notify of the success. This may initiate another calling tree (as above) to inform everyone that “The search is off”.

The behavioral function of “share” or “sharing” allows users to share information-rich SCLs with each other. This function can be made available in both Peer-to-Peer and Client-Server implementations of SCL sharing. The two modes are shown in the FIG. 4. In the Peer-To-Peer mode the list is shared between the clients (‘A’& ‘B’) directly. In the Client-Server mode the Publish-Subscribe mechanism is utilized, where the SCLs are published on a server that can then be downloaded by other clients. The users are then able to synchronize their lists or create new lists based on the shared information. While sharing their call lists, the users can choose to hide certain contacts or parts of the metadata associated with a contact in which case only the default values for the protected attributes will be shared.

With respect to structural functions, a proposed SCL management system can support functions that include creating, updating, deleting, synchronizing, or sorting of lists among other functions. The system can support manual user updates as well as updates based on synchronization with other information sources. In one system implementation, a user can override the values for the various metadata attributes as well as assign custom weights to the attributes. The user can utilize these weights to manually sort the list as well as drive the automatic selection. The Hierarchical SCL's support all of these functions for groups and subgroups.

Another structural function can include attribute extensions which can be useful for the carriers and network service providers. The list supports the ability to define custom attributes and associate it with the metadata. The associated behavior needs to be programmed such that the desired data is gathered and tracked.

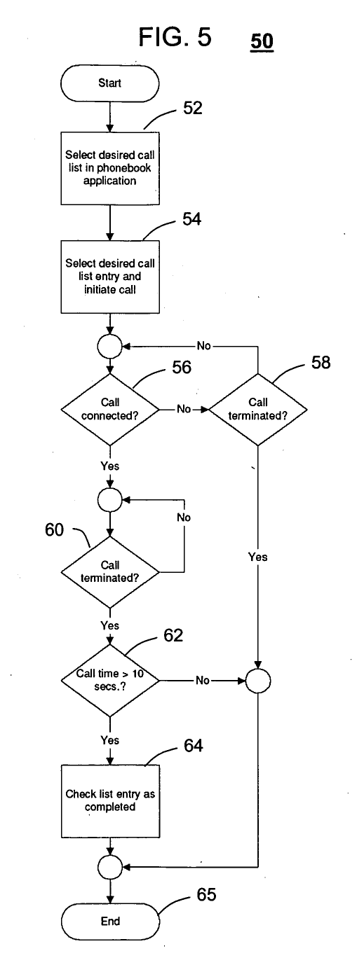

Referring to FIG. 5, a sample method 50 of traversing through a call list can include the step 52 of selecting a desired call list from a phonebook application and selecting a desired call list entry and initiating a call at step 54. If the call fails to connect at a decision block 56 and is terminated at decision block 58, then the call to the particular call list entry is finished at step 65. If the call fails to connect at a decision block 56 and is not terminated at decision block 58, then the call is checked again for a connection at decision block 56. If the call is connected at decision block 56 and terminated at decision block 60 and the call was longer than a predetermined time (such as 10 seconds) at step 62, then the particular call list entry is marked or checked as completed at step 64. Note, the call can be connected, terminated and be less than a predetermined time at decision block 62, in which case, the call is not checked as being completed. This process can go on recursively for each entry in a list.

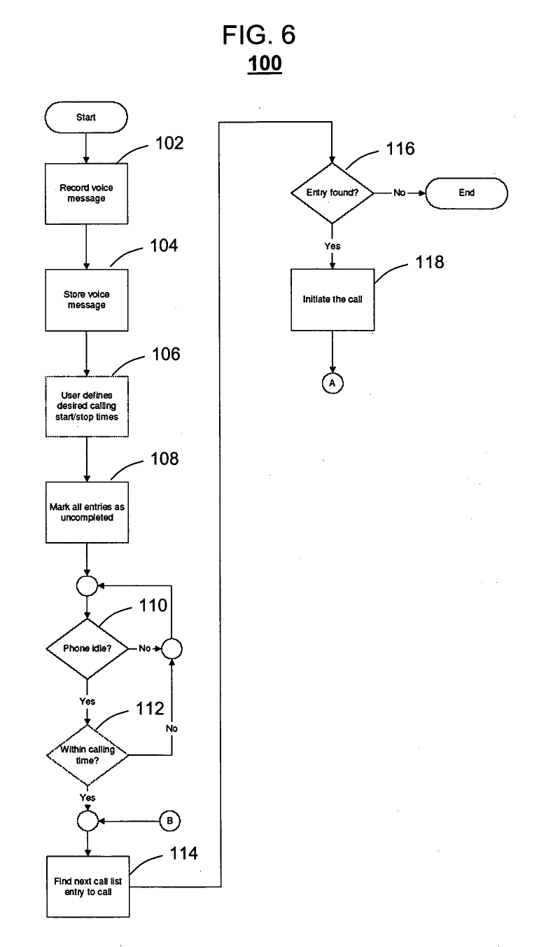

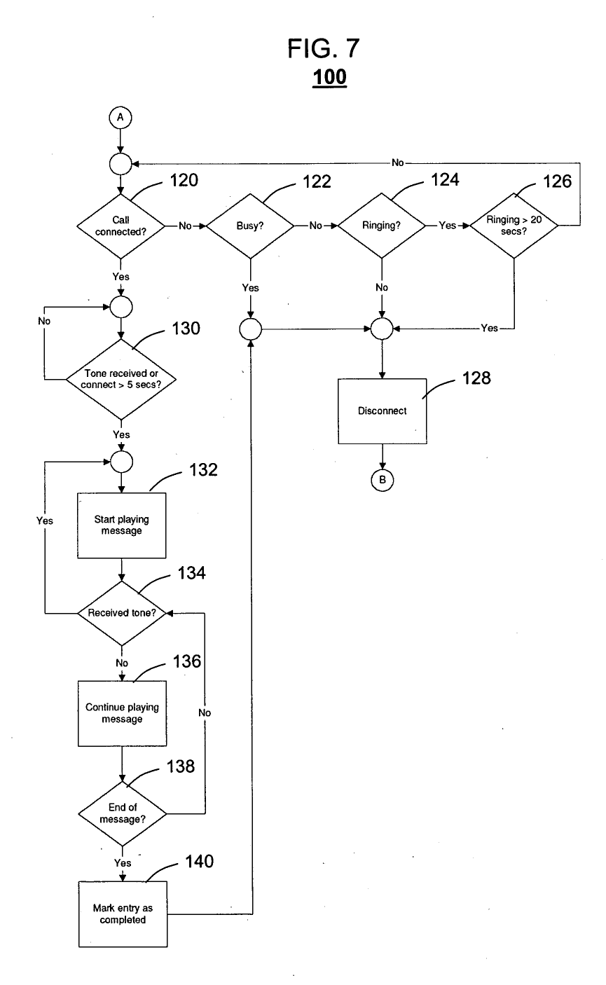

Referring to FIGS. 6 and 7, another method 100 of creating message and traversing through a call list can include the step 102 of recording a voice (or other type) message and storing the message at step 104. At step 106, a user can define desired calling start and stop times. Initially, the entries for a call list can be marked as “uncompleted” at step 108. If the phone is not otherwise in use at decision block 110 and within the defined calling time at decision block 112, the method 100 can seek the next entry to call from the call list at step 114. If a first or next entry is found at decision block 116, then a call to the found entry can be initiated at step 118 and the method moves on to step “A”. If no entry or additional entries are found at decision block 116, then method can end.

Referring to FIG. 7, if the call to the entry from the call list fails to connect at decision block 120, is busy at decision block 122, fails to ring at decision block 124 or rings for more than a predetermined time at decision block 126, then the call to the particular entry can be disconnected at step 128 and the method returns to “B” (shown in FIG. 6) to seek the next entry in the call list. If the ring is less than a predetermined time at decision block 126, then the method can return to determine once again if a connection is made at decision block 120. If the call is connected at decision block 120, and either a tone or a connection greater than a predetermined time period (e.g., 5 seconds) is found at decision block 130, then a message can be played at step 132 or restarted if a tone is received at decision block 134. If no tone is received at decision block 134, then the playing of the message can be continue at step 136 until the end of message is found at decision block 138. When the end of message is determined at decision block 138, the particular call list entry can be marked as completed at step 140 and the call can be disconnected at step 128 before seeking the next call entry from the call list.

Referring to FIG. 8, an electronic product or wireless device in the form of a computer system 300 can include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard or keypad), a satellite position system device 314 (e.g., a GPS receiver), a disk drive unit 316, a signal generation device 318 (e.g., a speaker or remote control or microphone) and a network interface device 320.

The disk drive unit 316 may include a machine-readable medium 322 on which is stored one or more sets of instructions (e.g., software 324) embodying any one or more of the methodologies or functions described herein, including those methods discussed below. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324 to one or more communication devices 328. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

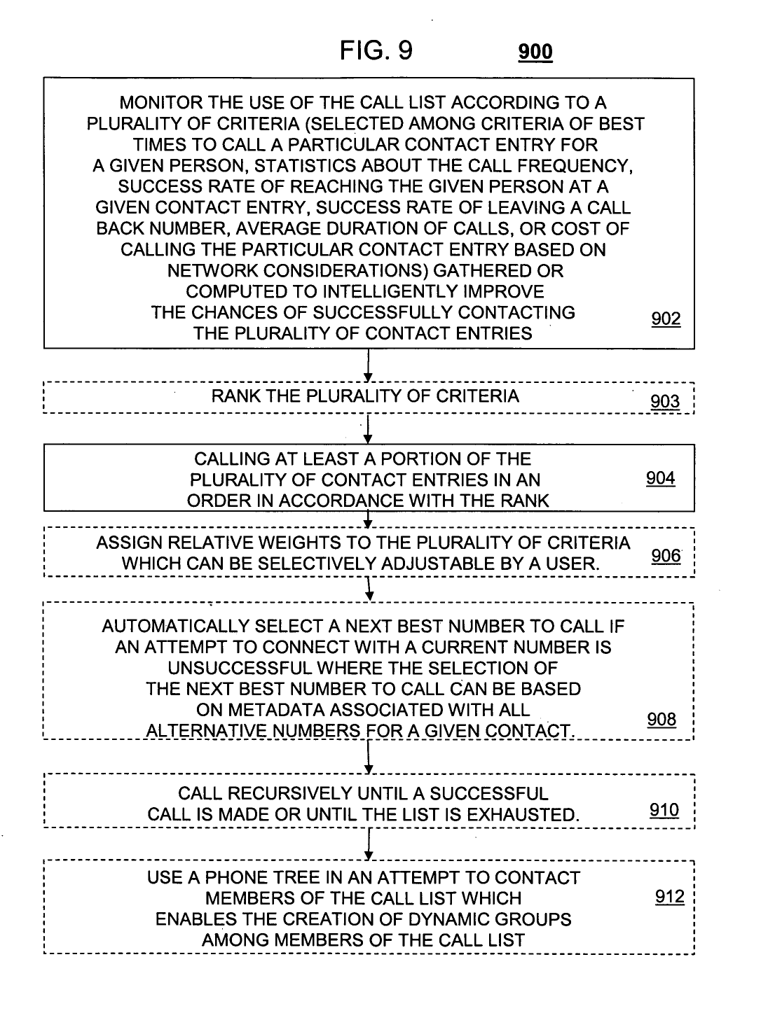

Referring to FIG. 9, a flow chart illustrating a method 900 of traversing a call list having a plurality of contact entries in a wireless mobile device can include the step 902 of monitoring the use of the call list according to a plurality of criteria gathered or computed to intelligently improve the chances of successfully contacting the plurality of contact entries on the call list, ranking at step 903 the plurality of criteria, and calling at least a portion of the plurality of contact entries in an order in accordance with the rank at step 904. The plurality of criteria can be selected among criteria of best times to call a particular contact entry for a given person, statistics about the call frequency, success rate of reaching the given person at a given contact entry, success rate of leaving a call back number, average duration of calls, or cost of calling the particular contact entry based on network considerations. The selection and order of the contact entries to contact can be facilitated by assigning relative weights to the plurality of criteria at step 906 which can be selectively adjustable by a user. The method 900 can automatically select a next best number to call if an attempt to connect with a current number is unsuccessful at step 908. The selection of the next best number to call can be based on metadata associated with all alternative numbers for a given contact. Calls can be made recursively at step 910 until a successful call is made or until the list is exhausted. In one arrangement, the call list can use a phone tree in an attempt to contact members of the call list at step 912. The call list can enable the creation of dynamic groups among members of the call list to form the phone tree.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A smart call list for a wireless mobile device, comprising:
a storage medium in the wireless mobile device containing a call list having a plurality of contact entries; and
a processor coupled to the storage medium, wherein the processor is programmed to monitor the use of the call list according to a plurality of criteria gathered or computed to intelligently improve the chances of successfully contacting the plurality of contact entries on the call list.

2. The smart call list of claim 1, wherein the processor is programmed to monitor the plurality of criteria based on best times to call a particular contact entry for a given person, statistics about the call frequency, success rate of reaching the given person at a given contact entry, success rate of leaving a call back number, average duration of calls, or cost of calling the particular contact entry based on network considerations.

3. The smart call list of claim 1, wherein the processor is further programmed to rank the plurality of criteria.

4. The smart call list of claim 3, wherein the processor is further programmed to assign relative weights to the plurality of criteria to facilitate a selection and order of the contact entries to contact.

5. The smart call list of claim 4, wherein the relative weights can be adjusted selectively by a user.

6. The smart call list of claim 1, wherein the processor is further programmed to automatically select a next best number to call if an attempt to connect with a current number is unsuccessful.

7. The smart call list of claim 6, wherein the selection of the next best number to call is based on metadata associated with all alternative numbers for a given contact.

8. The smart call list of claim 7, wherein calls are made recursively until a successful call is made or until the list is exhausted.

9. The smart call list of claim 1, wherein the smart call list uses a phone tree in an attempt to contact members of the call list.

10. The smart call list of claim 1, wherein the smart call list enables the creation of dynamic groups among members of the call list to form a phone tree.

11. A method of traversing a call list having a plurality of contact entries in a wireless mobile device, comprising the steps of:
monitoring the use of the call list according to a plurality of criteria gathered or computed to intelligently improve the chances of successfully contacting the plurality of contact entries on the call list;
ranking the plurality of criteria; and
calling at least a portion of the plurality of contact entries in an order in accordance with the rank.

12. The method of claim 11, wherein the method monitors the plurality of criteria based on best times to call a particular contact entry for a given person, statistics about the call frequency, success rate of reaching the given person at a given contact entry, success rate of leaving a call back number, average duration of calls, or cost of calling the particular contact entry based on network considerations.

13. The method of claim 11, wherein the method further comprises the step of facilitating a selection and order of the contact entries to contact by assigning relative weights to the plurality of criteria which are selectively adjustable by a user.

14. The method of claim 11, wherein the method automatically selects a next best number to call if an attempt to connect with a current number is unsuccessful.

15. The method of claim 14, wherein the selection of the next best number to call is based on metadata associated with all alternative numbers for a given contact.

16. The method of claim 15, wherein calls are made recursively until a successful call is made or until the list is exhausted.

17. The method of claim 11, wherein the call list uses a phone tree in an attempt to contact members of the call list.

18. The method of claim 11, wherein the call list enables the creation of dynamic groups among members of the call list to form a phone tree.

19. A wireless mobile device having a smart call list, comprising:
a transceiver;
a storage medium in the wireless mobile device containing a call list having a plurality of contact entries; and
a processor coupled to the storage medium and the transceiver, wherein the processor is programmed to:
monitor the use the plurality of contact entries of the call list according to a plurality of criteria gathered or computed to intelligently improve the chances of successfully contacting the plurality of contact entries on the call list; and
call at least a portion of the plurality of contact entries in an order determined by the plurality of criteria.

20. The wireless mobile device of claim 19, wherein the processor is further programmed to monitor and rank the plurality of criteria by assigning relative weights to the plurality of criteria, wherein the plurality of criteria are based on best times to call a particular contact entry for a given person, statistics about the call frequency, success rate of reaching the given person at a given contact entry, success rate of leaving a call back number, average duration of calls, or cost of calling the particular contact entry based on network considerations.
